(19) United States
(12) Patent Application Publication
(10) Pub. No.: US 2008/0235110 A1
(43) Pub. Date: Sep. 25, 2008

(54) SYSTEM AND METHOD FOR LISTING MULTIPLE ITEMS TO BE POSTED FOR SALE

(75) Inventors: Keith Marple Carter, San Francisco, CA (US); Ashley Gibson, Pacifica, CA (US)

Correspondence Address: Kacvinsky LLC, c/o Intellevate, P.O. Box 52050, Minneapolis, MN, 55402, US

(73) Assignee: STUBHUB, INC., San Francisco, CA (US)

(21) Appl. No.: 11/689,787

(22) Filed: Mar. 22, 2007

(51) Int. Cl. G06Q 30/00

(52) U.S. Cl. 705/27; 705/26

(57) ABSTRACT

A method and system for listing multiple items to be posted for sale, comprising accepting a characterization of an item from a choice of selection controls describing the item on a web page; accepting additional information about the item, the information being accepted on the web page; displaying the characterization and the information about the item as an item listing on the web page; accepting a characterization of another item from a choice of selection controls describing the item on the web page; accepting information about the other item, the information being accepted on the web page; and displaying the characterization and the information about the one other item listing on the web page.

### BRIEF DESCRIPTION OF THE DRAWINGS

FIG. 1 illustrates a system for listing multiple items to be posted for sale, according to one embodiment.

FIG. 2 illustrates a method for listing multiple items to be posted for sale, according to one embodiment.

FIGS. 3-9 are examples illustrating seller user interface screen shots, according to one embodiment.

### DESCRIPTION OF EMBODIMENTS OF THE INVENTION

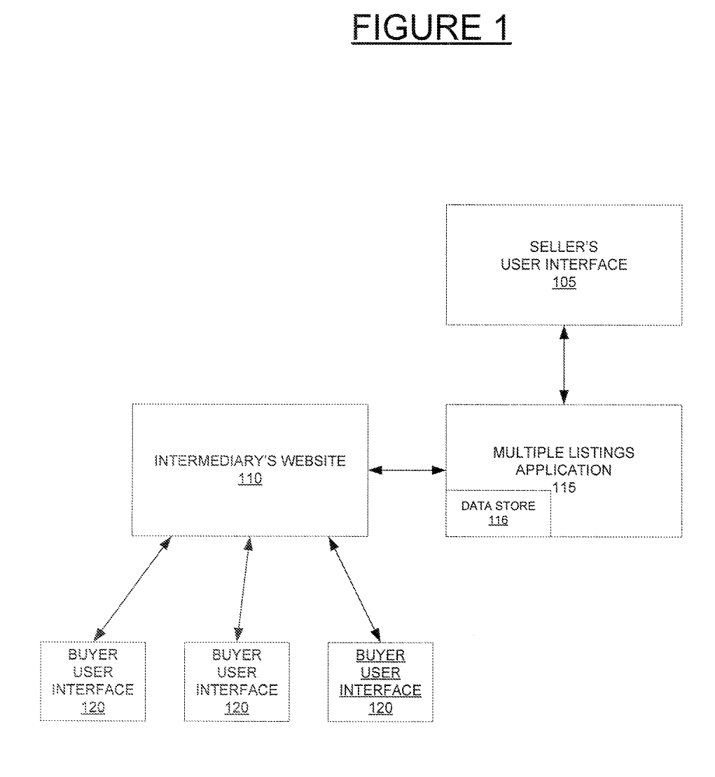

FIG. 1 illustrates a system for listing multiple items to be posted for sale, according to one embodiment, in the embodiment described below, the items are tickets that are to be posted for sale on a website. However, those of ordinary skill in the art will see that many other types of items (including services) can also be listed using the described system and method, including, but not limited to: any item for purchase (clothing, household items, books, spa treatments, collectibles, time shares, cars, or any other type of item that can be classified using a few meta fields. In addition, although the embodiment of the items being posted for sale is explained below, those of ordinary skill in the art will see that the items can also be posted by a user that wishes to buy the items.

Referring to FIG. 1, computer system 100 comprises a seller's user interface 105, which allows a user to enter multiple tickets for sale on a single HyperText Markup Language (HTML) page. Each request by the seller's user interface is made via Asynchronous JavaScript and XML (AJAX) calls to the multiple listings application. The AJAX calls combine various technologies (e.g., HTML, XHTML, cascading style sheets, JavaScript, Document Object Model, XML, XSLT, XMLHttpRequestObject) so that Web application are able to make quick, incremental updates to the seller's user interface without reloading the entire browser page. The AJAX call thus allow the seller to update and be presented with the next step of a flow in real-time. This results in a lightweight, rapid response process that minimizes server load and decreases the time needed for a seller to post an individual or several tickets through a single or multiple sessions.

Referring again to FIG. 1, the multiple listings application 115 accepts the entry of the information for the tickets. The seller uses the seller's user interface 105 to log into the seller's account in the multiple listings application 135. Those of ordinary skill in the art will see that any entity (e.g., a proxy or agent of the seller) can be substituted for the seller and can use the seller's user interface 105 to enter ticket information. The seller's account information must include a valid credit card and default contact, shipping, and billing addresses to calculate fees, logistics, and segmentation rules. In one embodiment, sellers can be manually authenticated. The sellers can agree to the terms arid conditions governing the use of the application. The seller's account is then enabled, whereby the user may view and use the application.

When the seller lists the tickets he has for sale, the entire seller experience is contained within one HTML page. The AJAX calls made to the multiple listings application 115 populate the HTML select controls presented to the user. The user is presented with a drop down of the genre options (nodes), such as sports, concerts, exclusive offers, theatre and arts tickets, and gift certificates. When the seller changes the value in a node, the change is detected, and an AJAX request is sent to the server. That request contains a form variable containing the genre ID selected by the seller. Thus, each selection from the selection controls results in an AJAX call that submits the genre identification and requests the children genres as an XML result set. The page then renders the results and inserts them as option values into a dynamically-generated child select controls.

When a ticket listing is saved, it can be validated. It can also be validated when the ticket listing is posted in case any information has changed. The validation process can include the following: validating that the user can sell on the cobrand they have accessed (cobrand partners can be a sports team, an entertainment artist, etc.); validate that the item (event) is active for sales; validate that there is a logistics method (fed ex, etc.) available for the seller's address; validate that the section, row, and comment fields contain sensical, legal characters and that too many characters have not been entered; validate that the quantity is numeric; validate that the splits amount makes sense given the quantity; and validate that the seller has not already listed the same tickets.

The data store 116 is a repository of ticket listings that persists across user sessions. In one embodiment, the data store 116 can be part of the multiple listings application 115. In another embodiment, the data store 116 can be separate from the multiple listings application 115. The ticket inventory stored in the data store 116 is not available as inventory ready for purchase on the intermediary's website 110, but is presented to the seller on the seller's user interlace 105. The seller has the option of modifying or removing any tickets from the data store 116 by selecting any one of the tickets and choosing from the following options: edit, delete, update prices. Once the tickets have been confirmed to be entered as active inventory, they are removed from the data store 116 and posted on the intermediary's website 110.

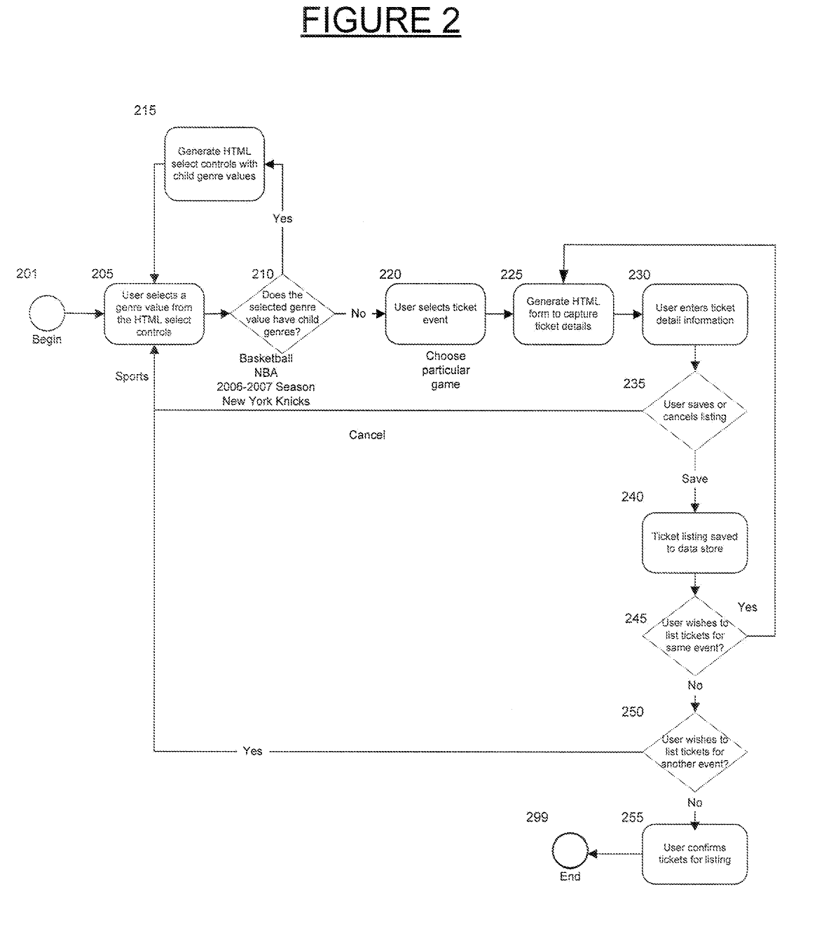

FIG. 2 illustrates a method for listing multiple items to be posted for sale, according to one embodiment. In 205, the user selects a genre value option from one or more HTML select controls. These select controls are populated with a hierarchical categorization of different event genres to allow the user to progressively narrow their specification of the event. For example, the genre value option could be sports, concerts, theatre, exclusives (special offers), etc. In 210, it is determined whether or not the selected genre has child genres. If yes, in 215 the user can choose from the child genres listed in the HTML select controls. In 210, it is determined if the previous child genre has additional child genres. If so, in 215, an additional child genre is chosen from the additional HTML select controls. The process set forth in 210 and 215 can repeat until no additional child genres are available. For example, if sports were chosen as the genre, the child genres could be basketball, then the NBA, then the 2006-2007 regular season, and then the New York Knicks. Because there are multiple levels possible in a genre drill-down, each select control is generated dynamically as needed using AJAX. The determination of whether an HTML select control is required, as well as the population of the control, is executed via an asynchronous application server call by the Javascript code on the client page. This allows for quicker user-interaction, reduced server load, and condensed steps in the listing process.

If the selected genre does not have any child genres, in 220, the user selects the event corresponding to the ticket. Thus, in 220, the Mar. 20, 2007 Dallas Mavericks @ New York Knicks event could be chosen.

In 225, once the event has been selected, an HTML form is generated using JavaScript. Once an event has been selected, we use Javascript to create a form on the fly for the user to enter section, row, etc. This sort of Javascript is commonly called Document Object Model (DOM) scripting. In 230, the seller describes each ticket to list by providing information via an HTML form interlace. The following information can be entered by the seller: quantity, whether ticket is general admission identification, section of ticket (if not general admission), row of ticket (if not general admission), ticket splits (i.e., whether the tickets can be sold individually, or only in sets of 2, 3, etc.), price, electronic ticket identification, and comments (e.g., good seats, seats partially blocked, etc.). In 235, upon completing the above information, the seller can choose to save or cancel this information. If the seller cancels the information, the process returns to 201. If the seller saves the information, in 240, the information is stored in the data store.

In 245, it is determined if the seller has additional tickets for the same event. If yes, the process returns to 255 and repeats. The seller is able to start with the same genres previously selected (e.g., sports, basketball, NBA, 2006-20007 regular season, New York Knicks), as well as the same ticket event (e.g., Mar. 20, 2007 Dallas Mavericks @ New York Knicks) and enter in information in the HTML form for another ticket for this specific event. If no, the seller does not wish to list additional tickets for the same event, the process moves to 250, where it is determined if the seller wishes to list another ticket for another event. If yes, the process returns to 205 and repeats. The seller is then able to repeat the process of choosing a parent genre and child genre(s) for another event, and entering in ticket information for this event.

In 255, once the seller has successfully listed his or her ticket inventory, the user can post the tickets. The seller is able to confirm ticket details during a final review before the tickets are made available on the intermediary's website for buyers to purchase.

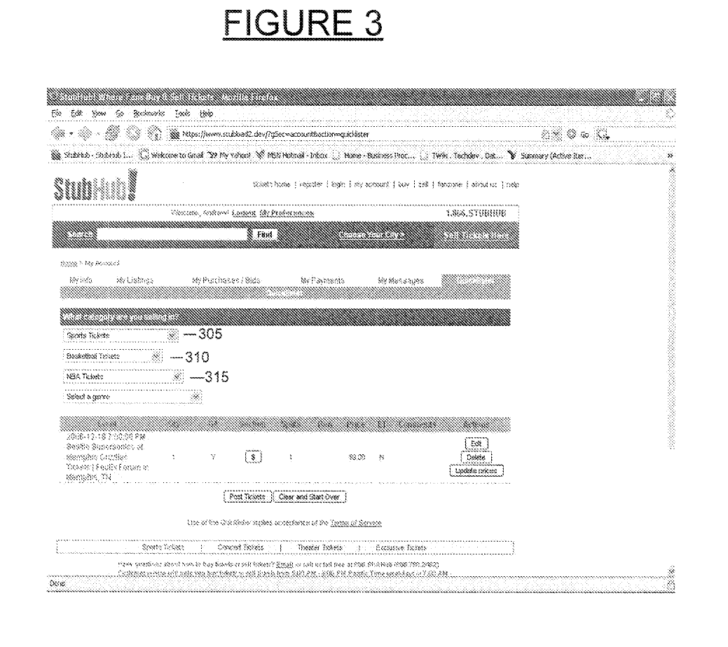

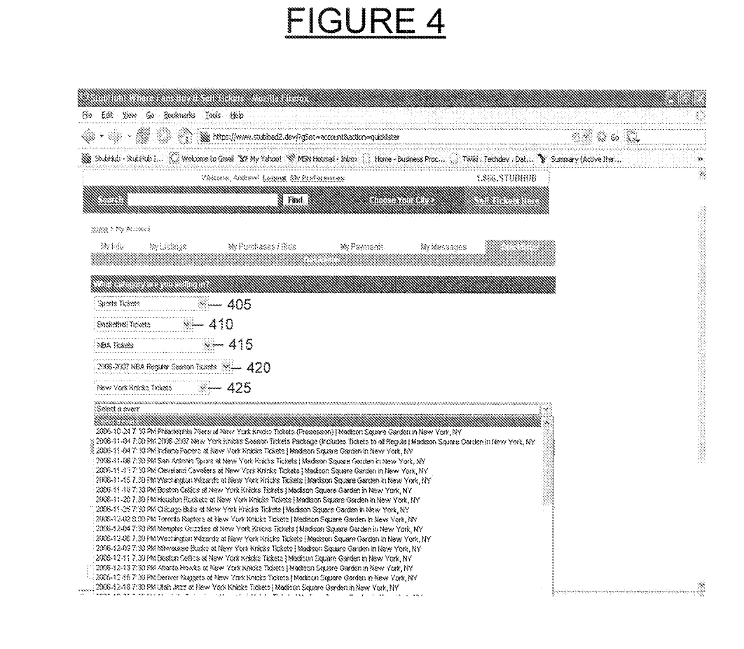

FIG. 3 is an example of a screen shot illustrating the parent and child genres select controls, according to one embodiment of the invention. In FIG. 3, the seller has navigated the parent genre Sports 305, and the child genres Basketball Tickets 310 and NBA Tickets 315. The seller continues to further drill-down into more specific child genres by selecting a child genre from the select control labeled “Select a genre” 320 until the event listings are available as depicted in FIG. 4.

FIG. 4 is an example of a screen shot illustrating the event choice select control, according to one embodiment of the invention. As noted above, after the seller has drilled down through all of the child genre select controls, the event listings select control is displayed. Here, the seller can choose a specific event.

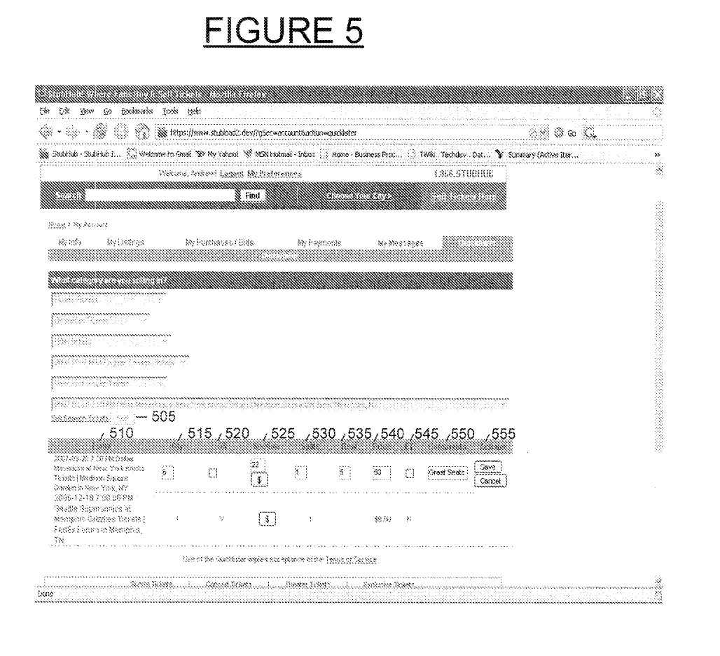

FIG. 5 is an example of a screen shot illustrating ticket information entry fields, according to one embodiment of the invention. Sellers are then presented with an HTML form that captures the information for which they wish to sell. The information fields include sell season ticket field 505, event field 510, quantity field 515, GA (general admission) field 520, section field 525, row field 535, ET (electronic ticket) field 545, comments field 530 and actions field 555. The sell season ticket link 505 takes the user away to another web page where the users can enter information to sell season tickets. The event field 510 displays the event for which the ticket is to be sold. The quantity field 515 allows the seller to enter in the number of tickets he or she is selling for the particular event listed in the event field 510. The GA field 520 allows the seller to check a box if the ticket is for general admission. If the ticket is not for general admission, the section field 525 and the row field 535 allow the seller to enter in the location of the ticket. The splits field 530 allows the user to designate how many tickets must be sold together (e.g., 1 at a time, or a set of 2, 3 or more). The price field 540 allows the seller to enter in his price. The ET field 545 allows the seller to check whether or not the ticket is an electronic ticket. The comments field 550 allows the seller to enter in comments about the tickets (e.g., great price, great seats, etc.). The actions field 555 allows the user to save or cancel the particular ticket entry. Note that, in one embodiment, all of the information on FIG. 5 is displayed on one web page (as opposed to multiple web pages, which could he done in another embodiment), making it convenient for the seller.

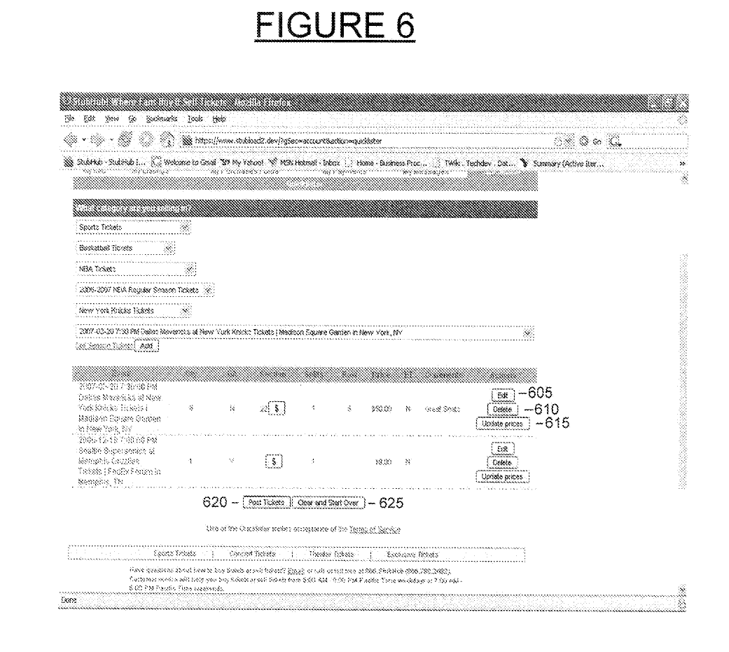

FIG. 6 is an example of a screen shot illustrating ticket information entry fields, according to one embodiment of the invention. After the user clicks ‘Save’ in the actions field 555, the tickets are stored in the data store. An AJAX call is generated to send the ticket data represented in XML form to the server, which is validated and then inserted into the data store with a unique identification number. Should the seller log out and return at a later date, the data store will populate the multiple listings application based on its current repository values for that seller. The data store is retrieved for each session (for pre-population) and provides the seller with the following ticket options: edit 605, delete 610, or update the price 615, which allows the user to repeat the steps in providing ticket detail information. Once the seller has saved the ticket information, the seller can either update their existing listings using the fields 605, 610 and/or 615, post, the tickets using the post field 620, or clear the data store records for the seller and begin the process over using the clear field 625. Clicking on the post tickets field 620 generates an AJAX call to the server instructing it to prepare the tickets for posting on the intermediary's website and return the sale end date, and fees and payout information for each ticket. The Javascript code renders the HTML form using Cascading Style Sheets (CSS). Once the user presses post tickets, the application sends a form variable to the server indicating that all of the tickets in the data store should be re-evaluated and have fees calculated for them. This information is returned to the browser as XML and parsed using Javascript. This technique is commonly referred to as AJAX. Javascript is used to change the display for the user. The new display shows the user the fees and seller payout and provides a button for confirming the posting. The user confirms the transaction by clicking ‘Post these tickets’ which makes a final AJAX call to the server which validates and processes the tickets and adds them as active inventory to the intermediary's website.

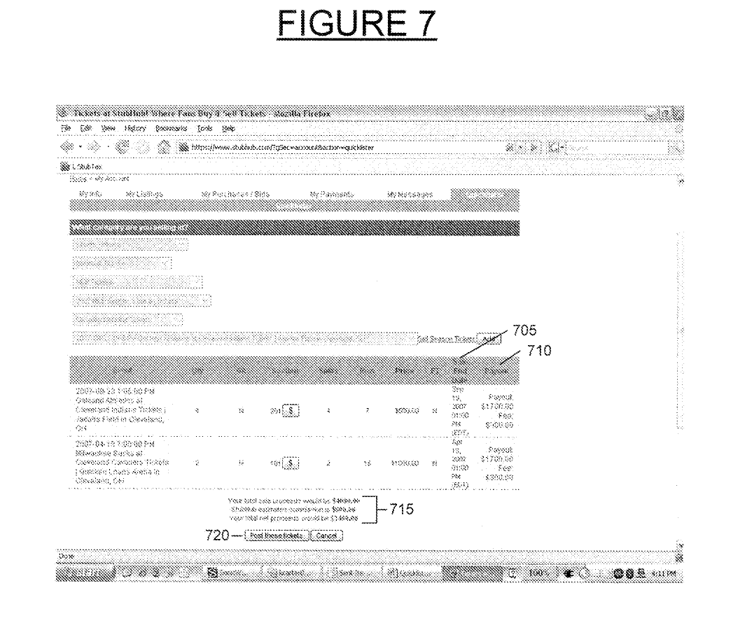

FIG. 7 is an example of a screen shot illustrating the sell end date, payout, and total payout fields, according to one embodiment of the invention. After clicking the post tickets field 620, the user is presented with the screen shot illustrated in FIG. 7. The sale end date field 70S allows the seller to enter the end date for the sale. The payout field 710 displays the payout for each set of tickets, and the fees for each set of tickets. The total payout field 715 displays the total payout for ail tickets listed by the seller. To complete the listings, the seller clicks the post these tickets field 720. The data store of ticket listings is then transferred to a live ticket inventory on the intermediary's website.

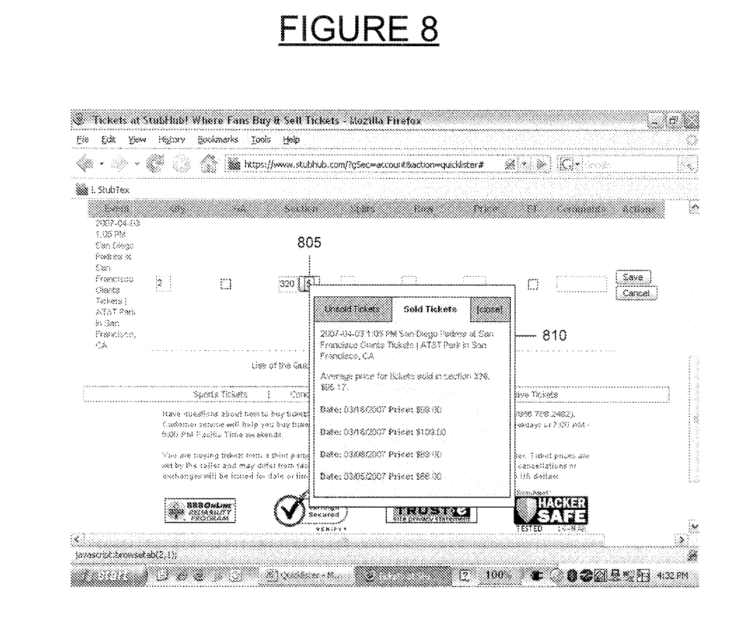

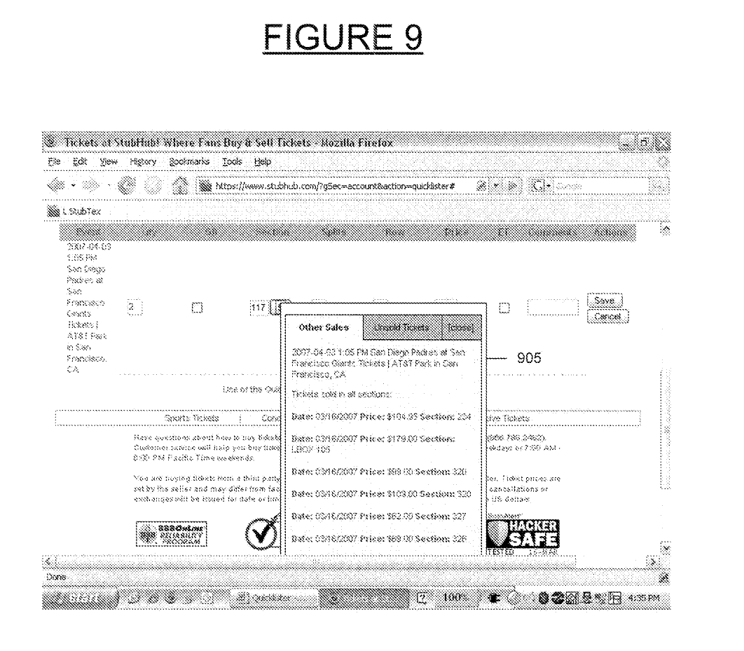

FIGS. 8-9 are examples of a screen shot illustrating a pricing history feature, according to one embodiment of the invention. If the seller clicks a dollar icon 805, information regarding historical pricing of similar tickets is displayed. In one embodiment, this pricing information is displayed on a pop-up screen. In the sold tickets pricing information 810, sellers are able to see pricing information regarding similar tickets and the price for which they were sold. In the unsold tickets pricing information 905, sellers are able to see pricing information for similar tickets that have been posted but not sold. In one embodiment, pricing information can be displayed for tickets in the same section and/or for tickets in other sections. In one embodiment, prices for tickets in other sections are shown only if there is no pricing information for tickets in the same section.

While various embodiments have been described above, it should be understood that they have been presented by way of example, and not limitation. It will be apparent to persons skilled in the relevant art(s) that various changes in form and detail can be made therein without departing from the spirit and scope of the present invention. In fact, after reading the above description, it will be apparent to one skilled in the relevant art(s) how to implement the invention in alternative embodiments. Thus, the present invention should not be limited by any of the above-described exemplary embodiments.

In addition, it should be understood that the figures, which highlight the functionality and advantages of the present invention, are presented for example purposes only. The architecture of the present invention is sufficiently flexible and configurable, such that it may be utilized in ways other than that shown in the accompanying figures.

Further, the purpose of the Abstract of the Disclosure is to enable the U.S. patent and Trademark Office and the public generally, and especially the scientists, engineers and practitioners in the an who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method for listing multiple items to be posted for sale, comprising:
accepting a characterization of an item from a choice of selection controls describing the item on a web page;
accepting additional information about the item, the information being accepted on the web page;
displaying the characterization and the information about the item as an item listing on the web page;
accepting a characterization of another item from a choice of selection controls describing the item on the web page;
accepting information about the other item, the information being accepted on the web page; and
displaying the characterization and the information about the one other item listing on the web page.

2. The method of claim 1, wherein the selection controls are HTML selection controls.

3. The method of claim 1, further comprising saving the item listing to a data store.

4. The method of claim 1, wherein multiple additional item listings can be accepted and displayed on the web page.

5. The method of claim 1, further comprising posting the item listing on a web site for a user to buy or sell.

6. The method of claim 1, wherein the additional information is accepted using free-form entry.

7. The method of claim 1, wherein the accepting a characterization of the item from a choice of selection controls describing the item comprises:
accepting a genre value describing the item from a choice of selection controls;
accepting a specified item related to the genre value from a choice of selection controls; and
accepting detail regarding the specified item related to the genre value.

8. The method of claim 7, wherein the selection controls are HTML selection controls.

9. The method of claim 1, further comprising:
canceling the item listing.

10. The method of claim 1, wherein the item and the at least one other item are similar.

11. The method of claim 1, wherein the item and the at least one other item are different.

12. The method of claim 1, further comprising:
generating an HTML form to accept item details.

13. The method of claim 1, wherein the item is a ticket for an event.

14. The method of claim 1, wherein the item is a ticket for an event, and the event is a sports event, a concert, a theatre event, or a special offer.

15. The method of claim 1, further comprising:
displaying comparable pricing information for the item.

16. A system for listing multiple items to be posted for sale, comprising a computer with an application capable of:
accepting a characterization of an item from a choice of selection controls describing the item on a web page;
accepting additional information about the item, the information being accepted on the web page;
displaying the characterization and the information about the item as an item listing on the web page;
accepting a characterization of another item from a choice of selection controls describing the item on the web page;
accepting information about the other item, the information being accepted on the web page; and
displaying the characterization and the information about the one other item listing on the web page.

17. The system of claim 16, wherein the selection controls are HTML selection controls.

18. The system of claim 16, wherein the application further comprises saving the item listing to a data store.

19. The system of claim 16, wherein multiple additional item listings can be accepted and displayed on the web page.

20. The system of claim 16, wherein the application further comprises posting the item listing on a web site for a user to buy or sell.

21. The system of claim 16, wherein the additional information is accepted using free-form entry.

22. The system of claim 16, wherein the accepting a characterization of the item from a choice of selection controls describing the item comprises:
accepting a genre value describing the item from a choice of selection controls;
accepting a specified item related to the genre value from a choice of selection controls; and
accepting detail regarding the specified item related to the genre value.

23. The system of claim 22, wherein the selection controls are HTML selection controls.

24. The system of claim 16, wherein the application further comprises canceling the item listing.

25. The system of claim 16, wherein the item and the at least one other item are similar.

26. The system of claim 16, wherein the item and the at least one other item are different.

27. The system of claim 16, wherein the application further comprises generating an HTML form to accept item details.

28. The system of claim 16, wherein the item is a ticket for an event.

29. The system of claim 16, wherein the item is a ticket for an event, and the event is a sports event, a concert, a theatre event, or a special offer.

30. The system of claim 16, wherein the application further comprises:
displaying comparable pricing information for the item.

31. A method for displaying pricing information, comprising:
accepting general information about an item on a web page;
displaying comparable pricing information for the item, the comparable pricing information being displayed on the web page; and
displaying the general information about the item as an item listing on the web page.

32. The method of claim 31, farther comprising:
accepting general information about another item on the web page;
displaying comparable pricing information for the other item, the comparable pricing information being displayed on the web page; and
displaying the general information about the other item as another item listing on the web page.

33. The method of claim 31, the comparable pricing information comprising:
comparable pricing information on similar items that have been sold; and/or
comparable pricing information on similar items that are listed for sale.

34. The method of claim 31, wherein accepting general information about an item comprises:
accepting a characterization of the item from a choice of selection controls describing the item on a web page; and
accepting additional information about the item, the information being accepted on the web page as free-form entry.

35. A system for displaying pricing information, comprising a computer with an application capable of:
accepting general information about an item on a web page;
displaying comparable pricing information for the item, the comparable pricing information being displayed on the web page; and
displaying the general information about the item as an item listing on the web page.

36. The system of claim 35, wherein the application further comprises:
accepting general information about another item on the web page;
displaying comparable pricing information for the other item, the comparable pricing information being displayed on the web page; and
displaying the general information about the other item as another item listing on the web page.

37. The system of claim 35, the comparable pricing information comprising:
comparable pricing information on similar items that have been sold; and/or
comparable pricing information on similar items that are listed for sale.

38. The system of claim 35, wherein accepting general information about an item comprises;
accepting a characterization of the item from a choice of selection controls describing the item on a web page; and
accepting additional information about the item, the information being accepted on the web page as free-form entry.

39. The method of claim 1, further comprising validating the item listing.

40. The system of claim 16, wherein the application further comprises validating the item listing.

41. The method of claim 31, wherein the pricing information is displayed as a pop-up screen on the web page.

42. The system of claim 35, wherein the pricing information is displayed as a pop-up screen on the web page.
